(19) United States
(12) Patent Application Publication
(10) Pub. No.: US 2011/0110070 A1
(43) Pub. Date: May 12, 2011

(54) REFLECTING CAP FOR ENHANCING ILLUMINANCE OF ILLUMINATION

(76) Inventors: Henry Hyung Kwang KIM, Sunnyvale, CA (US); Soon Hwang HONG, Seongnam-si (KR)

(21) Appl. No.: 12/613,745

(22) Filed: Nov. 6, 2009

(51) Int. Cl. F21V 9/16; F21V 7/00

(52) U.S. Cl. 362/84; 362/341; 362/355

(57) ABSTRACT

The present invention relates to a reflecting cap for enhancing an illuminance of an illumination, which can enhancing the illuminance, protect skin by UV blocking, prevent dazzling, used with being inserted on lamp of various existing illuminations and adjust an irradiation angle of the light freely. To this end, the present invention provides a reflecting cap for enhancing an illuminance of an illumination, which includes a sheet having a shape that is inserted on a lamp of an illumination so as to enhance an illuminance of the illumination. In accordance with the present invention, an illuminance is increased and an economic effect can thus be expected. Further, it is possible to adjust an irradiation angle of the illumination light by adjusting an angle of the sheet inserted on the lamp of the illumination.

### TECHNICAL FIELD

The present invention relates to a reflecting cap having a function of enhancing an illuminance of an illumination and function of blocking ultra violet light (UV), and more particularly, to an economic reflecting cap for enhancing an illuminance of an illumination, in which an illuminance of light emitted from an illumination is enhanced by the reflection cap and utilization is maximized by inserting the reflecting cap, having a function of blocking the UV from various lamps, in an existing illumination lamp.

### BACKGROUND ART

In general, a fluorescent illumination is equipped in offices, factories and houses to function to light the space equipped with the fluorescent illumination.

This fluorescent illumination has a predetermined illuminance to be emitted and a number of the fluorescent illumination to be quipped is determined depending on an area of the space equipped with the fluorescent illumination, and a plurality of the fluorescent illuminations is required when it is equipped in a wide space, which consumes a large amount of power.

To solve the aforementioned problem, there have been developed technologies for enhancing the illuminance emitted from one fluorescent illumination and thus capable of reducing the number of the fluorescent illuminations equipped in a predetermined space or obtaining higher illuminance with the same number of the fluorescent illuminations.

For example, Korean Utility Model Registration No. 20-015365 (registered on Jun. 12, 1999) discloses a reflecting shade for a fluorescent illumination.

This relates to a reflecting shade which enhances an efficiency in reflection of light emitted from the fluorescent illumination through a first reflecting part and a second reflecting part and thus increases brightness of light emitted from the fluorescent illumination.

However, this technology can increase the intensity of the light from the fluorescent illumination to some extent by reflecting the light, emitted to a direction opposite to a direction to which the fluorescent illumination lights, by a reflecting part, but has a problem that there is a limitation in an aspect of an efficiency in increasing the brightness through the reflecting panel.

Also, Korean Utility Model Registration No. 20-0179621 (registered on Feb. 11, 2000) discloses a high efficient reflecting shade for a fluorescent illumination.

This relates to a high efficient reflecting shade for a fluorescent illumination, which has a curved face with a large radius from a position close to the fluorescent illumination toward outside to thereby raise a reflecting efficiency and prevents lights emitted from two fluorescent illuminations from being collided to thereby maintain a high illuminance.

However, this can expectedly increase the illuminance to some extent by reflecting the light emitted from the fluorescent illumination through the reflecting shade, but also has a problem that the increase in the illuminance through the reflecting shade cannot be largely expected.

The aforementioned technologies have the limitation in increasing the illumination by reflecting light emitted from the fluorescent illumination through an inclined face of the reflecting panel, and there has accordingly been developed a technology capable of enhancing more an illuminance ratio of the light from the fluorescent illumination through a reflecting panel.

For example, Korean Patent Laid-open Publication No. 10-2008-0065951 (published on Jul. 15, 2008) discloses a fluorescent illumination device with improved reflecting efficiency by enlargement in a specular surface.

In this fluorescent illumination device with improved reflecting efficiency by enlargement in a specular surface, the entirety or a part of the specular surface of the fluorescent illumination body is formed in unevenly zigzagged form with each uneven surface provided with a plurality of engraved or embossed embossing to increase a scattered reflectance and also a reflecting shade formed in unevenly zigzagged form with each uneven surface provided with a plurality of engraved or embossed embossing is placed in the fluorescent illumination body to increase the scattered reflectance.

However, this technology can expectedly enhance increase in the illuminance of the light from the fluorescent illumination, as compared to the aforementioned technologies, by forming a plurality of engraved or embossed embossing on each uneven surface of the reflecting shade, but still has a problem that there is a limitation in increasing the illuminance of the from the fluorescent illumination only through a reflecting panel.

In all of the aforementioned prior technologies for enhancing the illuminance of the light from the fluorescent illumination, there is a limitation in enhancing the illuminance of the light from the fluorescent illumination only through the reflecting shade.

Further, since the reflecting shade for enhancing the illuminance of the light from the fluorescent illumination is formed integrally with the body of the fluorescent illumination device, there is a problem that it is impossible to use it in different kinds of fluorescent illumination bodies (for example, a body of a suspended illumination, a body of a wall illumination and a body of a down illumination).

Therefore, there are needs for development of an economic reflecting device capable of enhancing an illuminance of the fluorescent illumination as well as easily equippable in various kinds of the illuminations (a suspended illumination, a wall illumination, a down illumination and so on).

### DISCLOSURE

### Technical Problem

An object of the present invention is to provide a reflecting cap for enhancing an illuminance of an illumination, which can enhance the illuminance and can be inserted on a lamp of various existing illuminations, thereby capable of enhancing the illuminance as well as protecting skin by UV blocking, enhancing a workability by dazzling prevention, maximizing a utilization and adjusting an irradiation angle of the light.

### Technical Solution

To achieve the above object, the present invention provides a reflecting cap for enhancing an illuminance of an illumination, which includes a sheet having a shape that is inserted on a lamp of an illumination so as to enhance an illuminance of the illumination.

The reflecting cap includes: a front sheet which diffuses the light emitted from the lamp when the sheet is inserted on the lamp of the illumination; and a rear sheet which is adhered with both ends of the front sheet at both ends thereof to provide a space for receiving the lamp of the illumination and reflects or diffuses the light emitted from the lamp.

### Advantageous Effects

The reflecting cap for enhancing an illuminance of an illumination in accordance with the present invention can enhance the illuminance and can be inserted on a lamp of various existing illuminations, thereby capable of enhancing the illuminance as well as protecting skin by UV blocking, enhancing a workability by dazzling prevention, maximizing a utilization and adjusting an irradiation angle of the light.

Also, the reflecting cap has such a structure that is used with being inserted on the lamp of the illumination and thus can functions as a lamp cover. Therefore, it can expect some buffering effect when the illumination or lamp is accidently fell, and it also can expect that an accident due to the broken pieces upon the breakage of the lamp can be prevented to some extent.

Further, it is possible to adjust an irradiation angle of the illumination light by adjusting an angle of the reflecting cap inserted on the lamp of the illumination.

Furthermore, by enhancing a diffusion effect and illuminance of the illumination, it is possible to reduce a number of the illumination used in a predetermined space and resultantly reduce power consumption, thereby capable of expecting energy saving effect. Furthermore, it is possible to reduce an amount of CO2 generated upon power generation by the reduction of power consumption, and it is thus possible to provide a reflecting cap for enhancing an illuminance of an illumination capable of reducing environmental pollution. Furthermore, since the reflecting cap is made of recyclable material, it is possible [symbol] provide a reflecting cap capable of reducing the environmental pollution and being economically profitable.

In addition, by enhancing diffusion effect of illumination light through punched holes, it is possible to prevent a blur of the illumination and slim an illumination device for a billboard with expectation of reduction in a material cost according to the sliming.

### DESCRIPTION OF DRAWINGS

The above and other objects, features and advantages of the present invention will become apparent from the following description of preferred embodiments given in conjunction with the accompanying drawings, in which:

FIGS. 1 and 2 are perspective view illustrating an illumination equipped with a reflecting cap for enhancing an illuminance of an illumination in accordance with an embodiment of the present invention.

FIG. 3 is a perspective view illustrating a reflecting cap for enhancing an illuminance of an illumination in accordance with a first embodiment of the present invention.

FIG. 4 is an exploded perspective view illustrating a reflecting cap for enhancing an illuminance of an illumination in accordance with the first embodiment of the present invention.

FIG. 5 is an exploded perspective view illustrating a reflecting cap for enhancing an illuminance of an illumination in accordance with a second embodiment of the present invention.

FIG. 6 is a perspective view illustrating a reflecting cap for enhancing an illuminance of an illumination in accordance with a third embodiment of the present invention.

FIG. 7 is a perspective view illustrating a reflecting cap for enhancing an illuminance of an illumination in accordance with a fourth embodiment of the present invention.

FIG. 8 is a perspective view illustrating a reflecting cap for enhancing an illuminance of an illumination in accordance with a fifth embodiment of the present invention.

FIG. 9 is a sectional view illustrating an electronic display board employing the reflecting cap for enhancing an illuminance of an illumination in accordance with the fifth embodiment of the present invention.

[Detailed Description of Main Elements]

| | |
|---|---|
| 100: reflecting cap | 110: front sheet |
| 112: diffusion body | 114: first diffusion end |
| 116: second diffusion end | 120: rear sheet |
| 122: reflection body | 124: first reflection end |
| 126: second reflection end | 130: punched hole |
| 140: phosphorescent part | 200: lamp |
| 300: billboard | |

### BEST MODE

Hereinafter, embodiments of the present invention will be described in detail with reference to accompanying drawings.

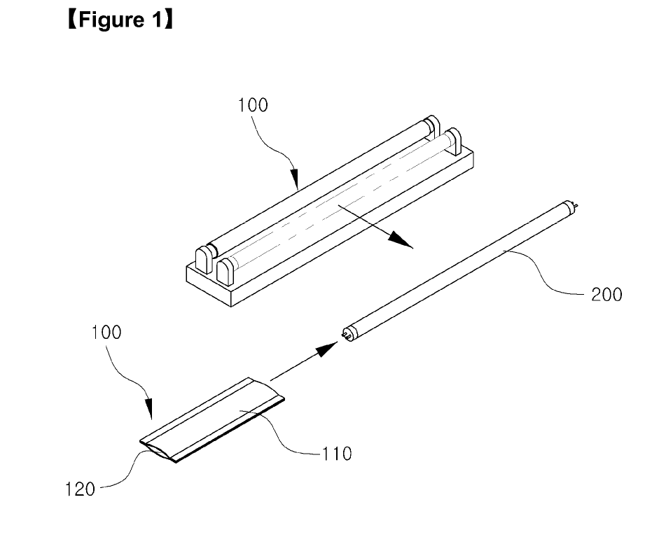

FIGS. 1 and 2 are perspective view illustrating a lamp equipped with a reflecting cap for enhancing an illuminance of an illumination in accordance with an embodiment of the present invention.

Referring to FIGS. 1 and 2, the reflecting cap 100 in accordance with an embodiment of the present invention includes a sheet inserted on a lamp of an illumination so as to enhance an illuminance of the illumination.

The sheet is for reflecting the light emitted from the lamp 200 of the illumination. More specifically, the sheet is formed in such a structure that is inserted on the lamp 200 of the illumination and thus can be easily equipped in various illuminations, for example, a suspended illumination, a wall illumination and a down illumination. This sheet is mainly used in a fluorescent illumination as illustrated in FIG. 1, or can be used in a bulb type fluorescent lamp or T8/T5 fluorescent illumination as illustrated in FIG. 2.

The sheet can be formed in a structure in that that one side thereof is opened and the other side is closed or in a structure in that both sides are opened so that it can be inserted on the lamp 200 of the illumination.

This reflecting cap 100 is of such a structure that is inserted on the lamp 200 of the illumination and it is thus possible to adjust a direction of the reflecting cap 100 with the reflecting cap 100 inserted on the lamp 200. As it is possible to adjust the direction of the reflecting cap 100, it is possible to adjust an irradiation angle of the light emitted from the lamp 200 of the illumination.

Hereinafter, each part of the reflecting cap in accordance with the present invention will be described in detail with reference to accompanying drawings.

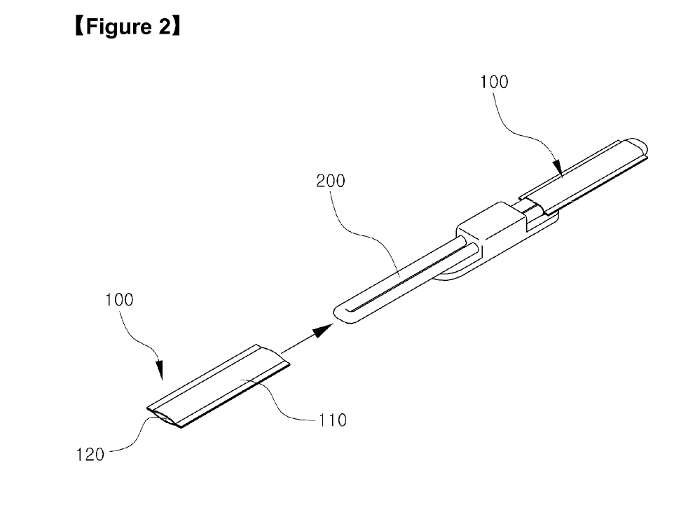

FIG. 3 is a perspective view illustrating a reflecting cap for enhancing an illuminance of an illumination in accordance with an embodiment of the present invention.

Referring to FIG. 3, the reflecting cap for enhancing an illuminance of an illumination in accordance with an embodiment of the present invention includes a sheet. The sheet includes a front sheet 110 and a rear sheet 120, and the front sheet 110 and the rear sheet 120 are adhered to each other at some portions thereof.

The front sheet 110 can employ a diffusion film which diffusely transmits the light emitted from the lamp 200 when the sheet is inserted on the lamp 200 of the illumination. Preferably, front sheet 110, i.e. the diffusion film is formed with a groove that facilitates insertion of the reflecting cap 100 on the lamp.

The rear sheet 120 is adhered with the front sheet 110 at some portions thereof to provide a space for receiving the lamp 200 of the illumination, and can employ a reflective light film which reflects the light emitted from the lamp 200 of the illumination toward a direction of the front sheet 110.

While the front sheet 110 and the rear sheet 120 can be adhered at any portions thereof provided that the reflecting cap 110 can be inserted on the lamp 200 of the illumination, it is preferred that both ends of the front sheet 110 and the rear sheet 120 are adhered with each other. Herein, while any method can be used provided that both ends 114, 116 of the front sheet 110 and both ends 124, 126 of the rear sheet 120 can be adhered with each other, respectively, it is preferred that both ends 114, 116 of the front sheet 110 and both ends 124, 126 of the rear sheet 120 are adhered with each other by high frequency heating with being in contact with each other. Alternatively, the front sheet 110 and the rear sheet 120 can be compressively coupled with each other with a metal member such as an aluminum having a shape of “⊂”, instead of the high frequency heating.

The front sheet 110 and the rear sheet 120 remains in nearly close contact with each other, and they are inserted on (coupled to) the lamp 200 of the illumination with the front sheet 110 and the rear sheet 120 being spaced apart from each other by a distance corresponding to a size (thickness) of the lamp 200 inserted therein. By this equipping method, the reflecting cap 100 can be equipped in lamps 200 of various sizes regardless of the size of the lamp 200. Also, the reflecting cap 100 can include the front sheet 110 and the rear sheet 120 or include integrally formed front sheet 110 and rear sheet 120 according to design purpose.

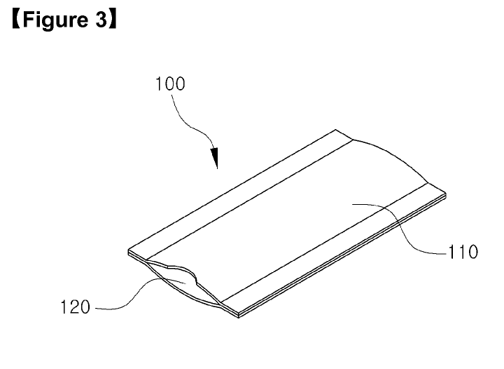

FIG. 3 is a perspective view illustrating a reflecting cap for enhancing an illuminance of an illumination in accordance with a first embodiment of the present invention, and FIG. 4 is an exploded perspective view illustrating a reflecting cap for enhancing an illuminance of an illumination in accordance with the first embodiment of the present invention.

Referring to FIGS. 3 and 4, the sheet in accordance with the first embodiment of the present invention includes the front sheet made of the diffusion film which diffuses the light emitted from the lamp of the illumination when the sheet is inserted on the lamp, and a rear sheet which is adhered with the front sheet at both ends thereof to provide the space for receiving the lamp and is made of the reflective light film for reflecting the light emitted from the lamp.

More specifically, the front sheet 110 includes a diffusion body 112 which diffuses the light emitted from the lamp of the illumination when the sheet is inserted on the lamp, and a first diffusion end 114 and a second diffusion end 116 which are formed extending from both ends of the diffusion body 112 along a length direction of the diffusion body 112 and come into contact with the rear sheet 120. Herein, the first diffusion end 114 and the second diffusion end 116, as illustrated in FIG. 4, can be formed to sizes as same as or similar to sizes of a first reflection end 124 and a second reflection end 126 which will be described later.

The rear sheet 120 includes a reflection body 122 which reflects the light emitted from the lamp 200 and the first reflection end 124 and the second reflection end 126 which are formed extending from both ends of the reflection body 122 along a length direction of the reflection body 122 and come into contact with the front sheet 110. Herein, the first reflection end 124 and the second reflection end 126, as illustrated in FIG. 4, can be formed to sizes as same as or similar to sizes of the first diffusion end 114 and the second diffusion end 116.

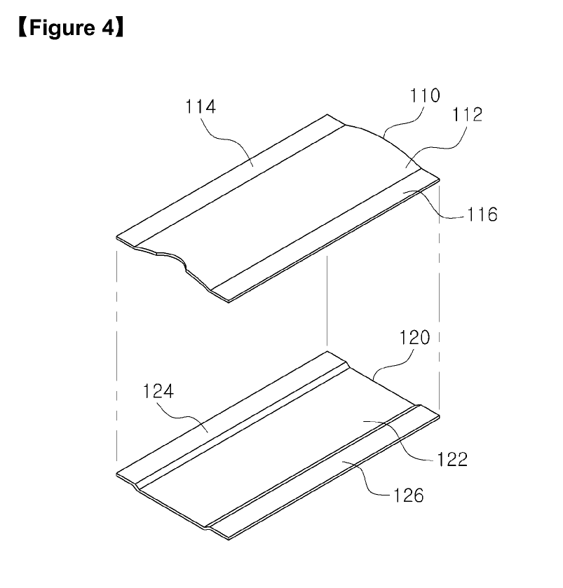

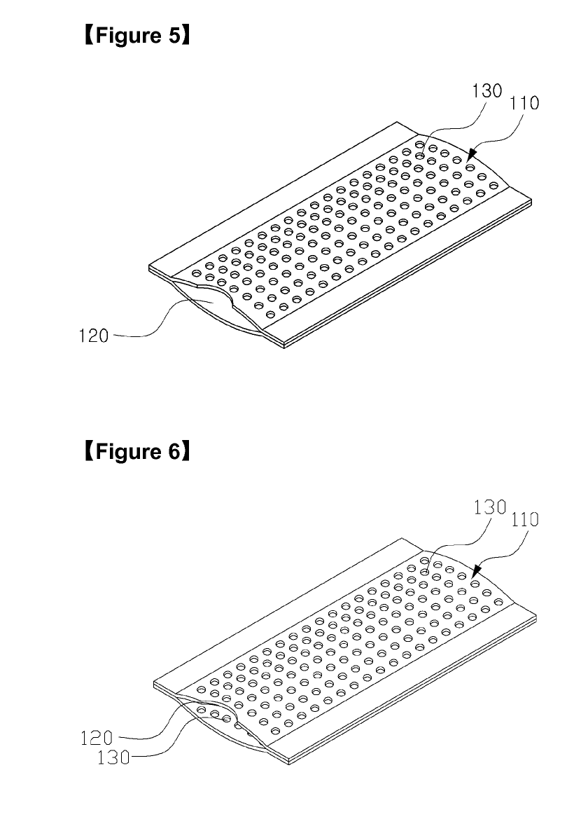

FIG. 5 is a perspective view illustrating a reflecting cap for enhancing an illuminance of an illumination in accordance with a second embodiment of the present invention, and FIG. 6 is a perspective view illustrating a reflecting cap for enhancing an illuminance of an illumination in accordance with a third embodiment of the present invention.

Referring to FIG. 5, the sheet includes the front sheet made of a punched reflective light film which diffusely transmits the light emitted from the lamp 200 when the sheet is inserted on the lamp 200 of the illumination, and the rear sheet 120 which is adhered with the front sheet at both ends thereof to provide the space for receiving the lamp and is made of the reflective light film for reflecting the light emitted from the lamp.

Referring to FIG. 6, in another embodiment, both the front sheet 110 and the rear sheet 120 can be formed of the punched reflective light film, and it is possible to give uniform illuminance in a wade area as the light is uniformly diffractively diffused through these punched reflective light film.

More specifically, the front sheet 110 can be made of an opaque reflective light film which is the same as that of the rear sheet 120 and of which light reflectance is enhanced using a stretched synthetic resin material. At this time, it is preferred that the front sheet 110 and the rear sheet 120 employ polyester based polyethyleneterephthalate (PET), or polypropylene (PP).

A number of the punched hole formed only on the surface of the front sheet 110 (the second embodiment, see FIG. 5) or formed on both surfaces of the front sheet 110 and the rear sheet 120 (the third embodiment, see FIG. 6) can be varied as the design purpose, provided that the uniform light illuminance can be obtained by diffusing the light emitted from the lamp 200.

Specifically, it is preferred to use such the form that both sheets are punched in cases of a signboard, a billboard in a bus stop and a standing board requiring the light is diffuse uniformly towards both sides of the illumination.

However, since a separate process of punching the reflective light film is required and the process takes cost, a separate punching is not necessary if a diffusion film with excellent diffusion performance, instead of the punched reflective light film, is used as a double sided sheet so that the light is diffused uniformly to the front side and rear side like the third embodiment. At this time, the diffusion film with excellent diffusion performance can employ a PET film, and specifically, CH283 (product name).

When the diffusion film with excellent diffusion performance is used as described above, since the light is diffused uniformly towards both sides and thus less number of the fluorescent illuminations can be used in the in cases of a signboard, a billboard in a bus stop and a standing board, it is possible to save energy and a blur of the fluorescent illumination is not generated due to the excellent diffusion performance even though some of the fluorescent illuminations is broken.

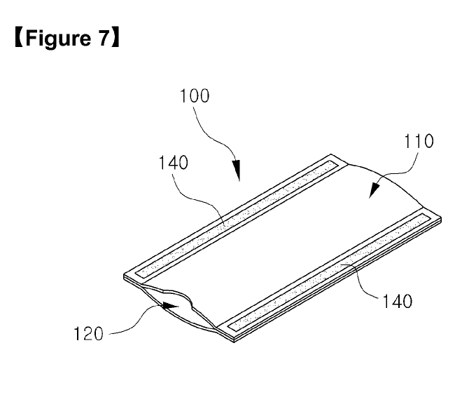

FIG. 7 is a perspective view illustrating a reflecting cap for enhancing an illuminance of an illumination in accordance with a fourth embodiment of the present invention.

Referring to FIG. 7, the reflecting cap 100 may further include a phosphorescent part formed at a portion where the front sheet 110 and the rear sheet 120 are adhered with each other.

Although the phosphorescent part 140 is placed at the portion where the front sheet 110 and the rear sheet 120 are adhered with each other in the present embodiment, the position of the phosphorescent part 140 can be changed according to design purpose.

The phosphorescent part 140 is coated with phosphorescent pigment which absorbs and discharges light energy.

The phosphorescent part 140, as it is coated with the phosphorescent pigment, can guide paths in the dark through light emitted from itself upon an electricity failure or fire. That is, the phosphorescent part 140, when it is used in an illumination equipped in an inside of a building, can guide an emergency exit or emergency step to a person moving in the inside of the building upon an emergency case such as the electricity failure, and can function as a lifeline by indicating a moving direction when an accident occurs in an underground facility such as an underground parking lot and an underground shopping center.

The phosphorescent pigment is an inorganic pigment, one of a noctiluscence pigment. The phosphorescent pigment has a basic properties as same as a fluorescent substance, but unlike the fluorescent substance, has a property in that an energy caused by the light energy previously received is discharged again as the light energy for some time even when the light is blocked.

This phosphorescent pigment has considerably enhanced luminance and afterglow time as compared to existing noctiluscence pigment and has a strong durability so that absorption and discharge of the light are continuously performed, and has a characteristic that the performance is not lowered in any condition.

An example of absorbable energy source may include natural light, incandescent light and artificial light used in daily life such as sunlight, mercury illumination, fluorescent illumination and incandescent illumination, and the more the white light is included e.g. in a sequence of sunlight, mercury illumination, fluorescent illumination, the higher an efficiency is.

That is, the energy absorptance is raised as the light has higher energy in a visible ray range, i.e. the light has a wavelength of around 400 nm more. This is resulted from that an absorption range of the phosphorescent pigment is mainly between 200 nm and 450 nm. Since a conventional room illumination mainly employs a fluorescent illumination, the aforementioned problem does not have an influence on the performance of the phosphorescent pigment.

Also, a phosphorescent efficiency is varied as an intensity of the light. That is, a sufficient abruption is made even in a short time for strong light such as the sunlight, but more time is taken for relatively weak light, e.g. the incandescent illumination.

In a room employing a conventional fluorescent illumination (less than 200 lux), about 30 minutes is enough to exhibit the performance.

Furthermore, the phosphorescent pigment does not contain heavy metals and radioactive substances, and thus has an excellent stability.

It is preferred that the phosphorescent pigment is coated on the phosphorescent part 140 by a silk printing. The silk printing is a printing method, which coats a film on a mesh and prints an ink flowed out through a portion not coated with the film, and is mainly used for a plane surface or circularly curved surface.

Meanwhile, the reflecting cap 100 may further include a finishing part (not shown) for selectively covering one side or both sides of the lamp 200 inserted in the reflecting cap 100 when it is formed in such a structure that one side or both side is opened At this time, although the finishing part can be formed in any form provided that it covers both sides of the reflecting cap 100 so as to cover both sides of the lamp 200, it is preferred that it is formed in such a structure that can be inserted in an outer peripheral surface of one side of the reflecting cap 100 or in such a structure that is extended from the front sheet or the rear sheet to cover the both sides. Particularly, the finishing part may be formed with a through groove for passing a terminal pin (not shown) therethrough in an inside of the finishing part.

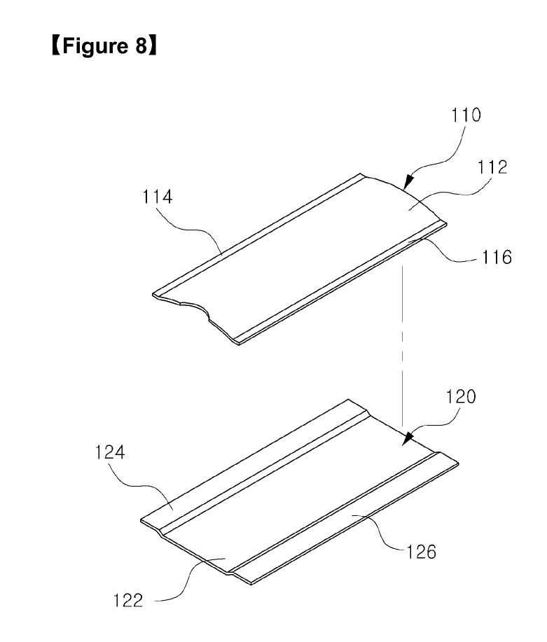

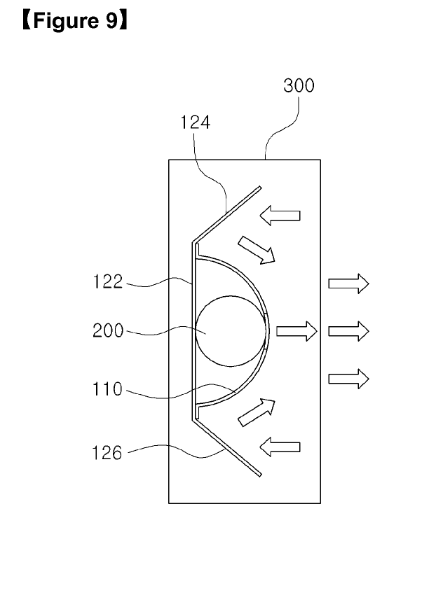

FIG. 8 is a perspective view illustrating a reflecting cap for enhancing an illuminance of an illumination in accordance with a fifth embodiment of the present invention, and FIG. 9 is a sectional view illustrating an electronic display board employing the reflecting cap for enhancing an illuminance of an illumination in accordance with the fifth embodiment of the present invention.

Referring to FIGS. 8 and 9, the reflecting cap in accordance with the fifth embodiment of the present invention includes the front sheet 110 and the rear sheet 120.

The front sheet 110 can employ a diffusion film and includes a diffusion body 112 which diffuses the light emitted from the lamp of the illumination when the sheet is inserted on the lamp, and a first diffusion end 114 and a second diffusion end 116 which are formed extending from both ends of the diffusion body 112 along a length direction of the diffusion body 112 and come into contact with the rear sheet 120. Herein, the first diffusion end 114 and the second diffusion end 116, as illustrated in FIG. 8, can be formed to widths narrower than those of the first reflection end 124 and the second reflection end 126.

The rear sheet 120 can employ a reflective light film and includes a reflection body 122 which reflects the light emitted from the lamp 200 and the first reflection end 124 and the second reflection end 126 which are formed extending from both ends of the reflection body 122 along a length direction of the reflection body 122 and come into contact with the front sheet 110. Herein, the first reflection end 124 and the second reflection end 126, as illustrated in FIG. 8, can be formed to widths wider than those of the first diffusion end 114 and the second diffusion end 126.

In a specific aspect, in the reflecting cap 10 in accordance with the present invention, the first diffusion end 114 and the second diffusion end 116 can be formed having the widths smaller than those of the first reflection end 124 and the second reflection end 126 and attached to the first reflection body 122, or the first reflection end 124 and the second reflection end 126 as illustrated in FIG. 9, so that it can be used in a signboard 300, preferably a billboard attached to an outer wall of a building. That is, the light emitted from the lamp 200 is not entirely but partially transmitted by a panel constituting the signboard 300. However, the reflecting cap 100 diffuses the light through the diffusion body 112 and the light not transmitted by the panel is reflected again toward the front side through the first reflection end 124 and the second reflection end 126 to thereby be transmitted through the panel. That is, when the reflecting cap 100 in accordance with the present invention is equipped in the illumination in an inside of the signboard, total illuminance of the signboard is enhanced.

It is preferred that the aforementioned diffusion film and reflective light film employ polyester based PET, or PP.

It is preferred that the diffusion film is formed transparently so as to transmit the light emitted from the lamp 200 of the illumination, and it is also preferred that the reflective light film is formed opaquely. Herein, it is preferred that the diffusion film which diffuses the light emitted from the lamp 200 of the illumination employs a diffusion film containing PET, and specifically, HB3 (product name). Also, when using a transparent PET film coated with a color pigment as the diffusion film, it is possible to present red, yellow, blue, green colors according to kinds of the pigment and thus the diffusion film can be used as an illuminating layout.

Also, the reflective light film which reflects the light emitted from the lamp 200 of the illumination is fabricated opaquely and is fabricated so as to enhance a reflectance of the light lamp 200 of the illumination. Although this reflective light film can employ any material capable of reflecting the light emitted from the lamp 200 of the illumination, in one aspect, it is preferred to employ a white polyester film having a reflectance of 96% or more, and it is more preferred to employ reflect all (product name) which shows a total reflectance of 99% or more and a diffuse reflectance of 96% or more.

In another aspect, the reflective light film which reflects the light emitted from the lamp 200 of the illumination can employ a stretched synthetic resin material. At this time, it is preferred for the stretched synthetic resin material to employ a crystalline synthetic resin material which is stretched under a temperature condition of less than a crystallization temperature (Tc). A crystalline region in this material for the reflection panel before the stretch diffuses the light but a non-crystalline region transmits the light. When a semitransparent crystalline plastic before the stretch is subjected to a low temperature stretch at a temperature of less than the crystallization temperature, the non-crystalline region is oriented and thus a diffused reflection occurs not only in the crystalline region but also the oriented non-crystalline region, thereby obtaining a high reflectance.

For example, since a general crystallization temperature is 160.8° C. for PET, the non-crystalline region is oriented and thus a sheet with enhanced reflectance can be obtained by stretching a crystalline synthetic region at a temperature lower than this crystallization temperature.

Herein, an example for the crystalline synthetic resin material may include polyethyleneterephthalate (PET), polyethylene 2,6-naphthalate (PEN), polybutyleneterephthalate (PBT), polypropylene (PP), polyethylene (PE), high density polyethylene (HDPE), low density polyethylene (LDPE), or linear low density polyethylene (LLDPE).

Also, the reflective light film and the diffusion film used as the front sheet 110 or rear sheet 120 of the reflecting cap for enhancing an illuminance of an illumination can be coated with an UV blocking agent on a surface thereof or employ a film coated with the UV blocking agent. Herein, the UV blocking agent can employ an UV blocking agent available from 3M Company. This is for protecting skin from being damaged by UV-A emitted from the lamp 200.

Further, the reflective light film and the diffusion film used as the front sheet 110 or rear sheet 120 of the reflecting cap for enhancing an illuminance of an illumination can be antistatic treated or employ an antistatic treated film to prevent generation of static electricity and resulting attachment of foreign substances. Herein, an example of the antistatic material may include phosphonium sulfonate. Besides, any antistatic material capable of preventing static electricity can be used.

As such, the diffusion film for diffusing the light can employ a diffusion film which is antistatic treated and is coated with an UV blocking agent, and specifically, CH283 (product name).

Also, the surface of either or both of the front sheet 110 and the rear sheet 120 can be coated with a photocatalyst, such as TiO2, for purifying and sterilizing air. The photocatalyst is activated heat and UV generated from the illumination to purify the air.

Those skilled in the art will appreciate that the conceptions and specific embodiments disclosed in the foregoing description may be readily utilized as a basis for modifying or designing other embodiments for carrying out the same purposes of the present invention. Those skilled in the art will also appreciate that such equivalent embodiments do not depart from the spirit and scope of the invention as set forth in the appended claims.

1. A reflecting cap for enhancing an illuminance of an illumination, comprising a sheet having a shape that is inserted on a lamp of an illumination so as to enhance an illuminance of the illumination, and having UV-A and UV-B blocking function.

2. The reflecting cap of claim 1, wherein a direction of the reflecting cap inserted on the lamp of the illumination is adjustable so as to adjust the light emitted from the illumination.

3. The reflecting cap of claim 1, wherein the sheet includes: a front sheet having a diffusion film which diffuses the light emitted from the lamp when the sheet is inserted on the lamp of the illumination; and a rear sheet adhered with both ends of the front sheet at both ends thereof to provide a space for receiving the lamp of the illumination and having an upper diffusion sheet formed with a groove for easy insertion on the lamp and a reflective light film which reflects the light emitted from the lamp.

4. The reflecting cap of claim 1, wherein the sheet includes: a front sheet having a diffusion film which diffuses the light emitted from the lamp when the sheet is inserted on the lamp of the illumination; and a rear sheet adhered with both ends of the front sheet at both ends thereof to provide a space for receiving the lamp of the illumination and having a diffusion film which diffuses the light emitted from the lamp.

5. The reflecting cap of claim 1, wherein the sheet includes: a front sheet having a diffusion film which diffuses the light emitted from the lamp when the sheet is inserted on the lamp of the illumination; and a rear sheet adhered with both ends of the front sheet at both ends thereof to provide a space for receiving the lamp of the illumination and having a reflective light film which reflects the light emitted from the lamp, wherein either or both of the front sheet and the rear sheet has punched holes which diffuse the light emitted from the lamp of the illumination to make the illuminance of the light uniform.

6. The reflecting cap of claim 1, wherein the sheet includes: a front sheet made of a diffusion film having a diffusion body which diffuses the light emitted from the lamp of the illumination when the sheet is inserted on the lamp, and a first diffusion end and a second diffusion end which are formed extending from both ends of the diffusion body; and a rear sheet made of a reflective light film having a reflection body which reflects the light emitted from the lamp towards the front sheet and a first reflection end and a second reflection end which are formed extending from both ends of the reflection body and have widths wider than those of the first diffusion end and the second diffusion end, wherein the first diffusion end and the second diffusion end are attached to the reflection body, or the first reflection end and the second reflection end.

7. The reflecting cap of claim 3, further comprising a phosphorescent part formed at a portion where the front sheet and the rear sheet are adhered with each other.

8. The reflecting cap of claim 3, wherein the diffusion film is HB3 or CH283.

9. The reflecting cap of claim 3, wherein the diffusion film includes: a transparent polyethyleneterephthalate (PET) film; and a pigment layer coated on the transparent PET film.

10. The reflecting cap claim 3, wherein the diffusion film is neo-bright.

11. The reflecting cap of claim 3, wherein the front sheet and the rear sheet are adhered with each other by high frequency heating with both ends thereof being in contact with each other or by compressing them with an aluminum member.

12. The reflecting cap of claim 3, further comprising a pair of finishing parts which are placed at both sides of the reflecting cap and have a through groove for passing a terminal pin of the lamp therethrough so as to cover both sides of the lamp inserted in the reflecting cap and facilitate insertion of the lamp by forming a groove in one side thereof.
